(19) United States
(12) Patent Application Publication
(10) Pub. No.: US 2008/0219188 A1
(43) Pub. Date: Sep. 11, 2008

(54) Home Media Switch

(75) Inventors: Lei Liu, Tucson, AZ (US); Hai Y. Zhang, Beijing City (CN); Ting Zhang, Beijing (CN)

Correspondence Address: INGRASSIA FISHER & LORENZ, P.C. (IBM), 7010 E. COCHISE ROAD, SCOTTSDALE, AZ, 85253, US

(73) Assignee: INTERNATIONAL BUSINESS MACHINES CORPORATION, Armonk, NY (US)

(21) Appl. No.: 11/683,259

(22) Filed: Mar. 7, 2007

(51) Int. Cl. H04L 12/28

(52) U.S. Cl. 370/257

(57) ABSTRACT

A media switch includes a backplane. A controller module is connected to the backplane for transferring a user command to a media device. A set of audio/video signal busses are connected to the backplane for transferring signals. A power bus is connected to the backplane for supplying power. A bus interface is connected to the bus to provide a connection point for the media device. A bus switch is positioned between the interface and the bus for transferring signals to the bus. The switch is operated by the controller module. A command bus is connected to the backplane for transferring a user command to the media device via a command interface.

### BACKGROUND OF THE INVENTION

1. Field of the Invention

The present invention relates in general to electronic devices, and more particularly to a switch apparatus for home media entertainment devices.

2. Description of the Prior Art

A variety of home media entertainment devices can be found in the marketplace. Examples include televisions, audio amplifier devices, compact disk (CD) video compact disk (VCD) and digital video disk (DVD) devices, and video tape players. A cable “set top” box is also commonplace in many homes.

In addition, many households are connecting various devices to home computer networks, such as laptop computers, desktop computers, television, video devices and the like. The combination of various devices provides a great deal of options of home entertainment. In addition, however, the combination also creates a number of problems as described below.

The interconnection of these various devices can be inconvenient. Every time a new device is added to the home media center, which is a cabinet normally, the user has to add a few sets of cables to connect the new device. The interconnection not only leaves a tangle of wires behind the cabinet, but also requires some efforts to figure out the wire scheme. Once a new connection is made, the user needs to remember the new configuration, as sometimes it is necessary to keep some device in the middle of the connection path powered on and set to certain channel, for example.

In addition, there is a possible reduction of signal quality through the use of various cables and interfaces. The longer the wire is, the more noise introduced and more signal lost. Each device, though compact, occupies the space of a standalone box, which takes up space. Finally, each device has an accompanying remote control. Though some universal remote controls are available, it is hard to find a truly universal remote. Furthermore, it is not easy to program remote controls.

### SUMMARY OF THE INVENTION

Though each real interconnection of home media devices is largely different from one another, the number of standards which regulate the interconnection is not large. These standards include coaxial, S-Video, HDMI, for example. A need exists for a home media switch which integrates these standards interconnections into a single device.

In one embodiment, the present invention is a media switch, comprising a backplane, a controller module connected to the backplane for transferring a user command to a media device, a set of audio/video signal bus of various standards connected to the backplane for transferring signals, and a bus interface connected to the bus to provide a connection point for the media device.

In another embodiment, the present invention is a media switch, comprising a backplane, a controller module connected to the backplane for transferring a user command to a media device, a set of audio/video signal bus of various standards connected to the backplane for transferring signals, a power bus connected to the backplane for supplying power, a command bus for transferring a user command to the media device via a command interface, a bus interface connected to the bus to provide a connection point for the media device, and a bus switch positioned between the interface and the bus, the bus switch operated by the controller module, for controlling signal transfer to the signal bus.

In still another embodiment, the present invention is a method of manufacturing a media switch, comprising providing a backplane, providing a controller module connected to the backplane for transferring a user command to a media device, providing a set of audio/videosignal bus of various standards connected to the backplane for transferring signals, and providing a bus interface connected to the bus to provide a connection point for the media device.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates an example home media switch device according to the present invention.

### DETAILED DESCRIPTION OF THE DRAWINGS

Some of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

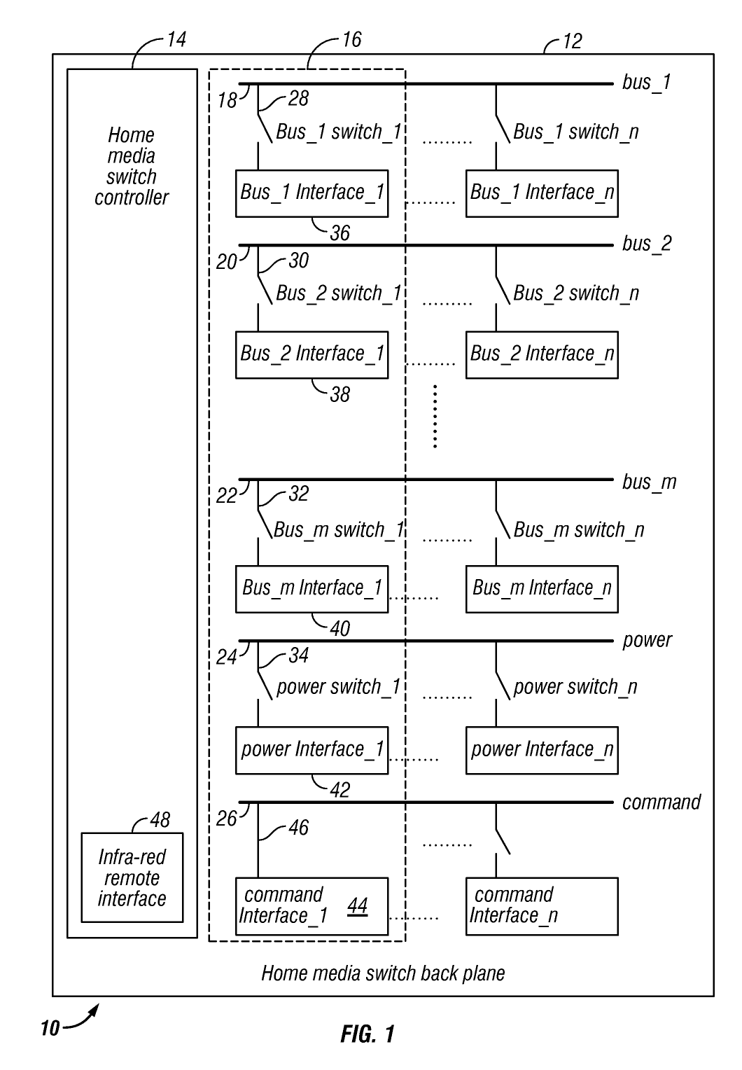

Turning to FIG. 1, an example home media switch device 10 in accordance with the present invention is illustrated. Switch 10 includes a backplane 12 through which various signal bearing mediums can be channeled. A home media switch controller module 14 can include processing components such as a central processing unit (CPU) which can control the overall function of the switch 10. The controller 14 can include such subcomponents as can be found in controller devices known in the art, such as memory devices, processing devices, and the like. In addition, various software, hardware, firmware, or a combination of hardware, software, and/or firmware can be operational on controller 14.

In the depicted embodiment, switch 12 includes a set 16 of standard components that can be linked together as shown. Several buses 18, 20, and 22 are connected to the backplane to route signals to and from media devices. Buses 18 can be adapted to accommodate audio and/or video signals. Any combination of buses 18, 20, 22, or more buses as needed, can be used to suit a particular application.

A power bus 24 is shown coupled to the backplane 12 to supply power. In one embodiment, power bus 24 supplies low voltage, DC power which can be utilized by peripheral media devices in a similar manner to the universal serial bus (USB) standard. Finally, a command bus 26 is shown coupled to backplane 12 to deliver user commands to a media device.

A series of bus switches 28, 30, 32 are shown coupled to buses 18, 20, and 22. Bus switches function to control the signal flow to or from a media device over a respective bus. As one skilled in the art would appreciate, a first bus switch 28 can be in the “on” position while remaining switches along bus 18 remain in the “off” position so as to direct signal flow to and from the switch 10. A command interface 44 is shown coupled to command bus 26 through signal bearing medium 46. Similarly, interfaces 36, 38, 40 and 42 provide respective interfaces between media devices and the switch 12.

Infrared remote interface 48 is shown integrated into controller 14. Interface 48 can include the depicted infrared functionality to receive infrared signals from a remote control which are then interpreted by the controller 14 to send user commands over the command bus 26. In addition, interface 48 can include functionality such as radio frequency (RF) implementations which may have a receiver device (not shown) or a similar apparatus which is integrated into controller 14 to receive RF signals from a remote control device.

Each bus_x (e.g., buses 18, 20) can represent a standardized audio/video signal transmission. In addition, each bus_x Interface_y (e.g., interfaces 38, 40) can represent a socket where audio/video devices can be plugged in and transfer signals.

Again, switch 10 consists of a back plane 12 and a controller module 14. The controller module 14 can be responsible for the user interface and transferring a user command to each media device connected to the backplane. 12. There are a set of audio/video buses (e.g., buses 18, 20, 22) available on the backplane, with accompanying interface slots (e.g., interfaces 36, 38, 40) for media devices to plug into. In one embodiment, interface slots 38 are implemented as a card form factor. All interface slots in the set 16 are available for use as a single device card. The controller module 14 can turn on/off the switches (e.g., switches 28, 30, 32) attached to the slots 36, 38, etc.

Because most audio/video connections are in a point to point nature, a switch (e.g., switches 28, 30, 32) can be positioned between each interface and the respective bus. The switches are all controlled by the controller module 14, which is in turn controlled by the user through a remote control, for example. Some interfaces 36, 38, 40, etc. can be designed as input or output only.

Again, the power bus 24 and switches 34 control the power supply to each media device based on user commands. The command bus 26 and interface 44 are used to transfer a user command from the remote control to the targeted media device. In the physical level, the bus could be implemented in various ways. At the logical level, a communication protocol can be defined to convey the basic commands operating on a home audio/video device, e.g. play/stop/forward/backward/record/volume/channel, etc. The command interface on each device can work the same way, as the device receives commands from its own infrared or RF remote control interface.

Each interface_y (e.g., interfaces 36, 38, and 40) on each bus can include a slot (not shown) for one audio/video devices, which, again, can be implemented in a card shape form factor. The architectural layout of the card and the interfaces can be standardized so that manufacturers of each device can make their devices compatible with the home media switch 10. Finally, a set of specialized interfaces can be integrated into the backplane 12 and configured to connect a television device, which may be difficult to integrate in a card form factor.

Software and/or hardware to implement the switch 10 can be created using materials and tools currently known in the art. Implementing and utilizing the example switch as described can provide a simple, effective method of integrating a host of connecting media devices to reduce space, promote signal quality, and provide for greater ease of connection and operability. While one or more embodiments of the present invention have been illustrated in detail, the skilled artisan will appreciate that modifications and adaptations to those embodiments may be made without departing from the scope of the present invention as set forth in the following claims.

What is claimed is:

1. A media switch, comprising:
a backplane;
a controller module connected to the backplane for transferring a user command to a media device;
a signal bus connected to the backplane for transferring signals; and
a bus interface connected to the bus to provide a connection point for the media device.

2. The switch of claim 1, further including a bus switch positioned between the bus interface and the signal bus, the bus switch operated by the controller module, for controlling signal transfer to the signal bus.

3. The switch of claim 1, wherein the controller module is operable by a remote control device.

4. The switch of claim 1, wherein the bus interface is configured for an input or output-only function.

5. The switch of claim 1, wherein the signal bus accommodates a video or audio signal.

6. The switch of claim 1, wherein the controller module implements a communication protocol defined to convey basic operating commands to the media device via the command bus.

7. The switch of claim 1, wherein the bus interface is configured in a card form factor.

8. The switch of claim 1, further including a power bus connected to the backplane for supplying power.

9. The switch of claim 8, further including a power interface and power switch connected to the power bus to control the supply of power.

10. The switch of claim 1, further including a command bus connected to the backplane for transferring a user command to the media device via a command interface.

11. A media switch, comprising:
a backplane;
a controller module connected to the backplane for transferring a user command to a media device;
a signal bus connected to the backplane for transferring signals;
a power bus connected to the backplane for supplying power;
a command bus connected to the backplane for transferring a user command to the media device via a command interface;
a bus; interface connected to the bus to provide a connection point for the media device; and
a bus switch positioned between the interface and the bus, the bus switch operated by the controller module, for controlling signal transfer to the signal bus.

12. The switch of claim 11, wherein the controller module is operable by a remote control device.

13. The switch of claim 11, wherein the bus interface is configured for an input or output-only function.

14. The switch of claim 11, wherein the signal bus accommodates a video or audio signal.

15. The switch of claim 11, wherein the controller module implements a communication protocol defined to convey basic operating commands to the media device via the command bus.

16. The switch of claim 11, wherein the bus interface is configured in a card form factor.

17. The switch of claim 11, further including a power interface and power switch connected to the power bus to control the supply of power.

18. A method of manufacturing a media switch, comprising:
providing a backplane;
providing a controller module connected to the backplane for transferring a user command to a media device;
providing a signal bus connected to the backplane for transferring signals; and
providing a bus interface connected to the bus to provide a connection point for the media device.

19. The method of manufacture of claim 18, further including providing a bus switch positioned between the bus interface and the signal bus, the bus switch operated by the controller module, for controlling signal transfer to the signal bus.

20. The method of manufacture of claim 18, further including providing a power bus connected to the backplane for supplying power.
